(19) United States
(12) Patent Application Publication
(10) Pub. No.: US 2007/0053753 A1
(43) Pub. Date: Mar. 8, 2007

(54) Boring head

(76) Inventor: Karl-Heinz Wenzelburger, Riederich (DE)

Correspondence Address: Wolff & Samson, One Boland Drive, West Orange, NJ, 07052, US

(21) Appl. No.: 10/583,798

(22) PCT Filed: Jul. 16, 2004
(86) PCT No.: PCT/DE04/01547

§ 371 Date: Nov. 13, 2006

(30) Foreign Application Priority Data
Jul. 18, 2003 (DE) 103-33-061.5

(51) Int. Cl. B23B 51/10

(52) U.S. Cl. 408/83

(57) ABSTRACT

The invention relates to a boring head (100), comprising at least one guide element (140), arranged on the periphery thereof, and at least one cutting insert (150), also arranged on the periphery, whereby the guide elements (140) as well as the at least one cutting insert (150) are supported by cassettes (200, 205) which are guided in grooves (160, 165) in a sliding manner. Said boring head is characterized in that an adjustment means (400; 410; 460; 470) is provided for adjusting and aligning the projecting end of both the at least one guide element (140) and the at least one cutting insert (150) on the periphery of the boring head housing (110). Said adjustment means is adjacent to the cassettes (200; 205), on the sides thereof which are opposite to the at least one guide element (140) or to the at least one cutting insert (150). The shape of the adjustment means, in the peripheral direction, is adapted to the radial distance between the cassettes (200; 205) and the axis of symmetry of the boring head (100), so that the projecting end of both the guide elements (140) and the at least one cutting insert (150) is adjusted and aligned simultaneously with the mounting of the adjustment means (400; 410; 460; 470) on the boring head (100).

### BACKGROUND OF THE INVENTION

The present invention relates to a boring head comprising a plurality of guide elements arranged on the periphery thereof and at least one cutting insert, arranged on the periphery, where both the guide elements and the cutting insert are supported by cassettes which are guided in grooves for substantially radial displacement.

DE 28 52 298 A1 discloses a multi-cut boring head comprising a plurality of multi-edge cutting plates which are arranged on the periphery of the boring head and which project beyond the face of the boring head body, and at least one guide strip or guide shoe, arranged between the cutting plates or at the level of the space between the cutting plates, which radially project beyond the periphery of the boring head body, wherein a circular cutting plate known as such is arranged between two multi-edge cutting plates on the periphery of the boring head body, and projects beyond the face of the boring head body, the cutting section of the periphery of the cutting plate being located, in axially off-set fashion, behind the cutting section of the multi-edge cutting plates, and a guide shoe being provided behind the circular cutting plate, at or approximately at the axial level of the cutting plates.

A boring head having one or more cutters, with at least one of them being movable, has been described by DE 42 27 730 A1. In the case of that boring head, the cutters are arranged in cassettes that fit into pockets in the boring head. At least one of the cassettes can be radially moved by a wedge or a toothed rod via a pull rod. In addition, that boring head may comprise an arrangement, consisting of at least two radially arranged damping strips, which likewise can be moved in radial direction.

In the case of such boring heads the boring diameter, i.e. the length of projection of the cutting insert, as well as the length of projection of the guide elements beyond the periphery of the boring head are each adjusted by separate adjustment of the different cassettes, such adjustment of the boring diameter being possible not only by the before-mentioned pull rod or toothed rods, but also, for example, by wedges that can be displaced in axial direction or by spacer elements of substantially cuboid shape that are inserted on the side of the cassette opposite the periphery of the boring head.

Adjusting the arrangement in this way requires very much time and is, in addition, susceptible to faults.

It is, therefore, an object of the invention to develop a boring head of the before-mentioned kind so that precise adjustment of both the cassettes carrying the guide elements and the cassettes carrying the cutting inserts is rendered possible with the least possible input of technical instrumentation and time.

### ADVANTAGES AND DESCRIPTION OF THE INVENTION

This object is achieved, in a boring head of the kind defined in the preamble, in that a single adjustment means is provided for adjusting and aligning the boring diameter, i.e. the length of projection of both the guide elements and the at least one cutting insert beyond the periphery of the boring head, the adjustment means being adjacent to the cassettes, on the sides thereof which are opposite to the guide strips and to the at least one cutting insert, respectively, and having a shape, in the peripheral direction, adapted to the cassettes in such a way that the length of the guide elements and of the at least one cutting insert projecting beyond the periphery of the boring head is adjusted and aligned simultaneously as the adjustment means is mounted on the boring head.

It is the basic idea of the invention to permit adjustment of the boring diameter, i.e. the length of projection of both the guide strips and of the at least one cutting insert, to be effected simultaneously by a single adjustment means, the adjustment and alignment being carried out by the action of mounting that adjustment means on the boring head. It then is not necessary to separately adjust the cassettes carrying the guide strips and the at least one cassette carrying the at least one cutting insert, which is very favorable. Moreover, the single adjustment means allows the adjustment to be carried out with considerably greater precision, compared with the prior art where the different cassettes are adjusted separately using the adjustment means associated to each cassette, as faults that otherwise may occur in the case of repeated adjustments are definitely prevented because only a single adjustment means has to be mounted and because the adjustment is predefined by the mounting arrangement.

Preferably, the adjustment means can be mounted on the face of the boring head. The face of the boring head being readily accessible this permits easy and rapid mounting and, thus, easy and rapid adjustment.

Preferably, the adjustment means is arranged centrally, substantially concentrically, to the axis of the boring head. Another embodiment may, however, also provide that the adjustment means is arranged eccentrically to the axis of the boring head.

In principle, the adjustment means may have any desired shape, including especially an unsymmetrical shape, which would be desirable, for example, in a case where different lengths of displacement of the cassettes need to be adjusted due to different cassette sizes.

Advantageously, the adjustment means is cylindrical in shape, in the axial direction. This makes its production especially easy.

An advantageous embodiment then provides that the adjustment means have a flat disk-like shape.

According to another embodiment, the adjustment means have an annular shape. The annular shape permits an especially advantageous arrangement of centering bores in the boring head.

According to preferred embodiments, the disk-shaped adjustment means have the shape of a circular disk, and the annular adjustment means have the shape of a circular ring. The embodiment as a circular ring or a circular disk is of particular advantage as regards the rapid, easy and at the same time very precise production of those parts as turned parts.

In addition, the adjustment means may also have a conical shape, being preferably arranged for axial displacement. This allows the boring diameter to be rapidly varied by simply displacing the conical adjustment means in axial direction.

Preferably, the cassettes can be fixed after adjustment and alignment by detachable mounting elements, especially by screws.

In order to permit any chips produced during the boring operation to be carried off without any problem, it is provided that the at least one cassette, carrying the at least one cutting insert, comprises a chip removal channel which is connected with a chip removal channel provided in the interior of the boring head in both the non-displaced and the displaced condition of the cassettes. This guarantees best possible chip removal for differently adjusted diameters of the boring head.

Further, the boring head is preferably provided on its periphery with damping strips the radial extension of which is adapted to the adjustable length of projection of both the guide elements and the cutting insert and, thus, to the boring diameter.

According to an advantageous embodiment, intended to protect the adjustment means and the cassettes, it is provided that a cover covering at least part of the adjustment means and of the cassettes is mounted on the face of the boring head.

### DRAWING

Further advantages and features of the invention will be apparent from the description that follows and the exemplary embodiments illustrated in the drawings in which:

FIG. 1 shows a diagrammatic representation of a boring head using the invention;

FIG. 2 shows a top view of the boring head illustrated in FIG. 1, viewed in the direction of its face;

FIG. 3 shows a sectional view of the boring head according to FIG. 1;

FIG. 4 shows the boring head illustrated in FIG. 1, using a different adjustment means;

FIG. 5 shows a top view of the boring head illustrated in FIG. 4;

FIG. 6 shows a sectional view of the boring head illustrated in FIG. 4;

FIG. 7 shows a diagrammatic representation of the adjustment means and the cassettes of the boring head illustrated in FIG. 1;

FIG. 8 shows a diagrammatic representation of the adjustment means and the cassettes of the boring head illustrated in FIG. 4;

FIG. 9 shows an alternative adjustment means and the cassettes for the boring head illustrated in FIG. 1 or FIG. 4, respectively;

FIG. 10 shows an alternative adjustment means and the cassettes for the boring head illustrated in FIG. 4;

FIG. 11 shows a sectional view of a further embodiment of a boring head using the invention, with a planar connection; and

FIG. 12 shows a sectional view of another embodiment of a boring head using the invention, with an external thread.

### DESCRIPTION OF THE EMBODIMENTS

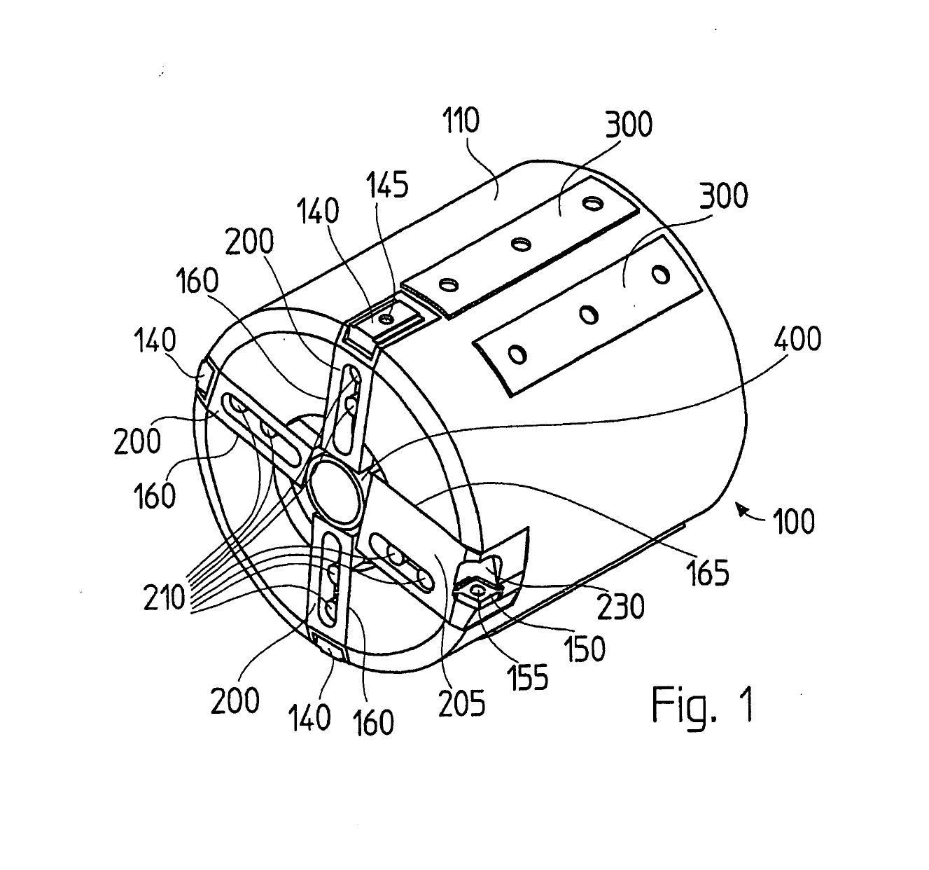

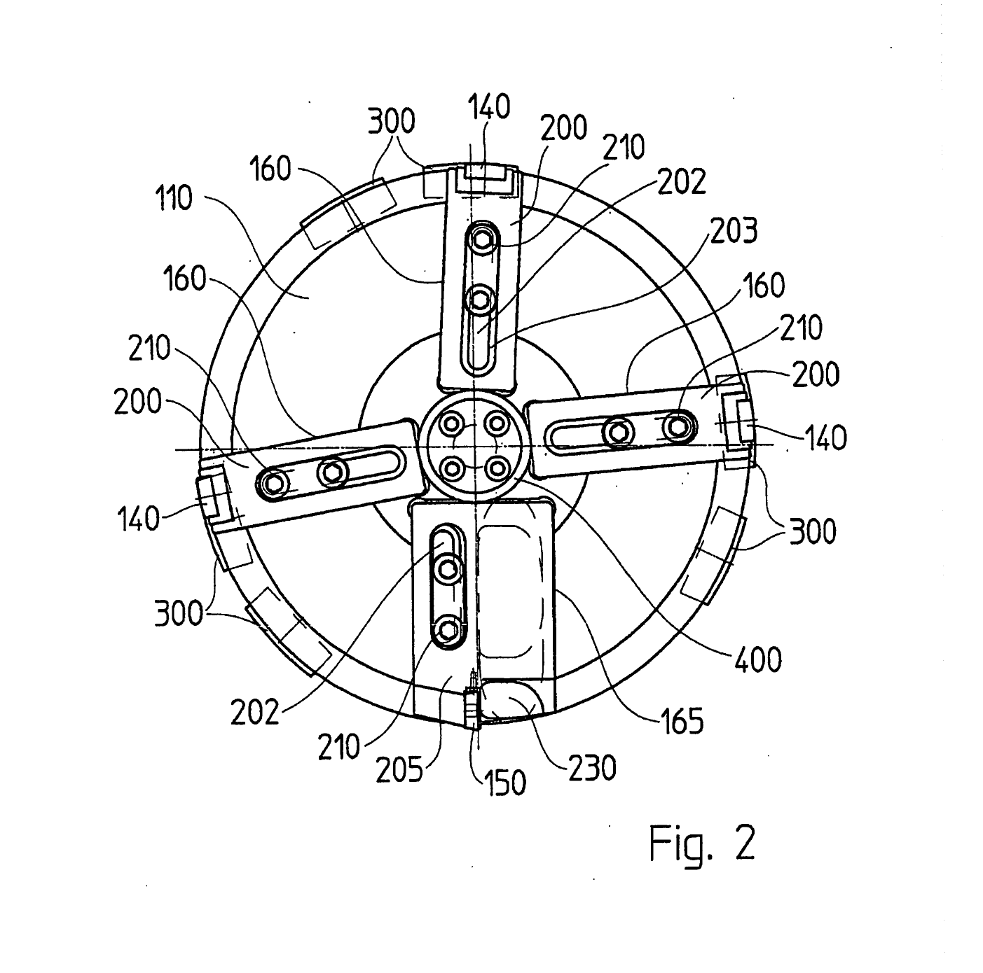

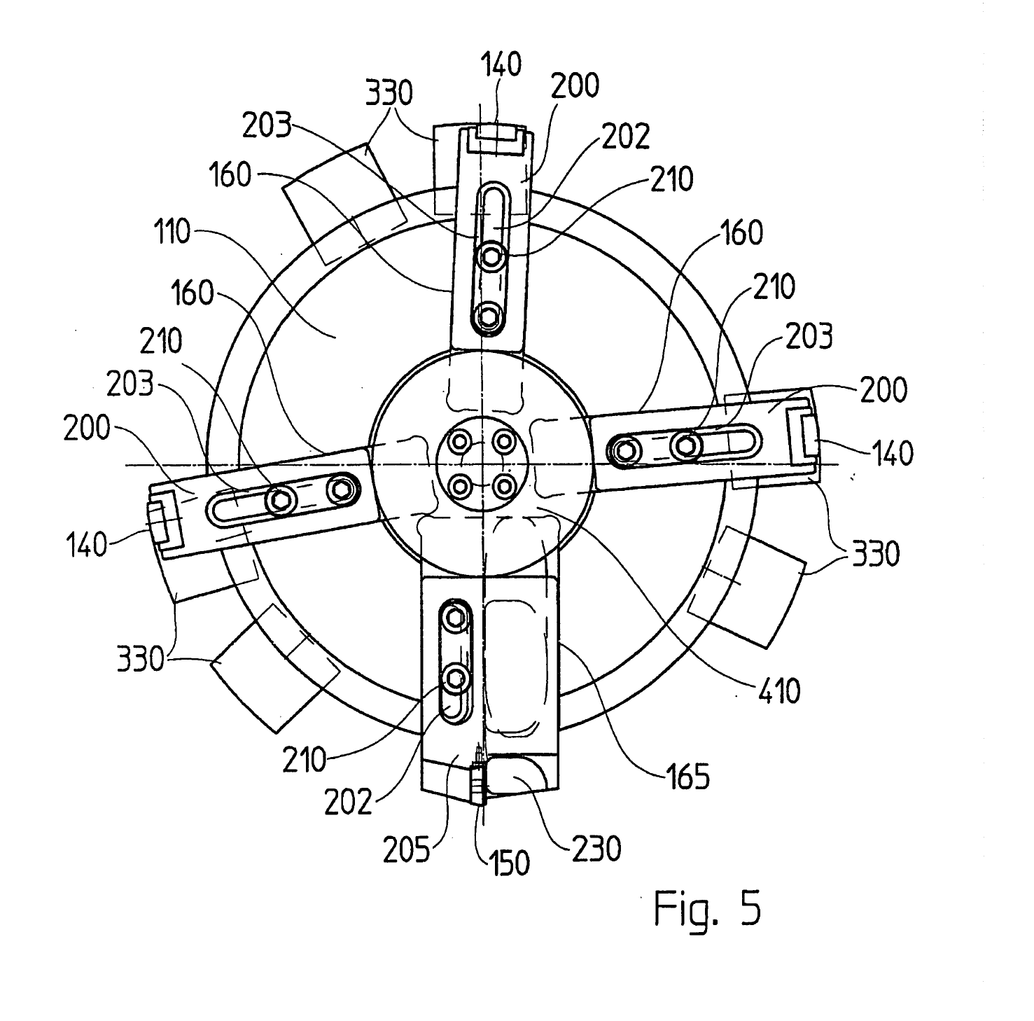

A boring head of hollow configuration illustrated in FIGS. 1 to 6 and indicated generally by reference numeral 100 comprises a substantially cylindrical housing 110 having a plurality of guide elements 140 arranged on its periphery and a cutting insert 150 likewise arranged on its periphery. Both the guide elements 140 and the cutting insert 150 are carried by cassettes 200, 205 that are guided in grooves 160, 165 provided at the face of the boring head 100, for being displaced substantially in radial direction of the boring head 100. Following a displacement of the cassettes 200, 205, which will be described hereafter in more detail, the cassettes are fixed in the displaced position for example by screws 210 arranged in oblong holes 202 provided in the cassette housing. Fixing the cassettes 200, 205 is achieved by clamping them with the aid of the heads of the screws 210 by means of the circumferential projection 203 in the oblong hole 202 on the side facing the end face of the boring head 100.

For guiding the boring head 100, there are further provided on the periphery of its housing 110 damping strips 300 which extend in parallel to the axis of the boring head 100 and whose radial projection beyond the housing 110 of the boring head 100 is adapted to the diameter to be bored and, thus, to the lengths of the radial projections of both the cutting insert 150 and the guide elements 140. The damping strips or guide strips 300 are made from a material softer than the material of the workpiece to be worked, and are detachably fixed on the housing 110 by means of screws 310, for example.

For adjusting and aligning the boring diameter, the screws 210 are untightened so that the cassettes 200 and 205 can be displaced in the guiding grooves 160, 165. An adjustment means, for example one having the shape of a circular ring 400, is then arranged on the face of and coaxially to the boring head 100. The outer diameter of the circular ring 400 is suitably sized so that when the sides of the cassettes 200, 205 opposite the guide strips 140 and/or the cutting insert 150 are in contact with the circular ring 400, precise adjustment of the diameter to be bored is guaranteed. To say it in other words: For effecting the adjustment and alignment, the cassettes 200, 205 are merely displaced radially toward the circular ring 400 until they are in contact with the latter's outer surface. Following the adjustment, the position of the cassettes is secured by the screws 210 in the manner described above, whereby the boring diameter is fixed.

After adjustment of the boring diameter, the guide strips 300 are fastened on the housing 110 of the boring head by means of the screws 310, the thickness of the guide strips 300 in their radial direction being adapted to the diameter to be bored.

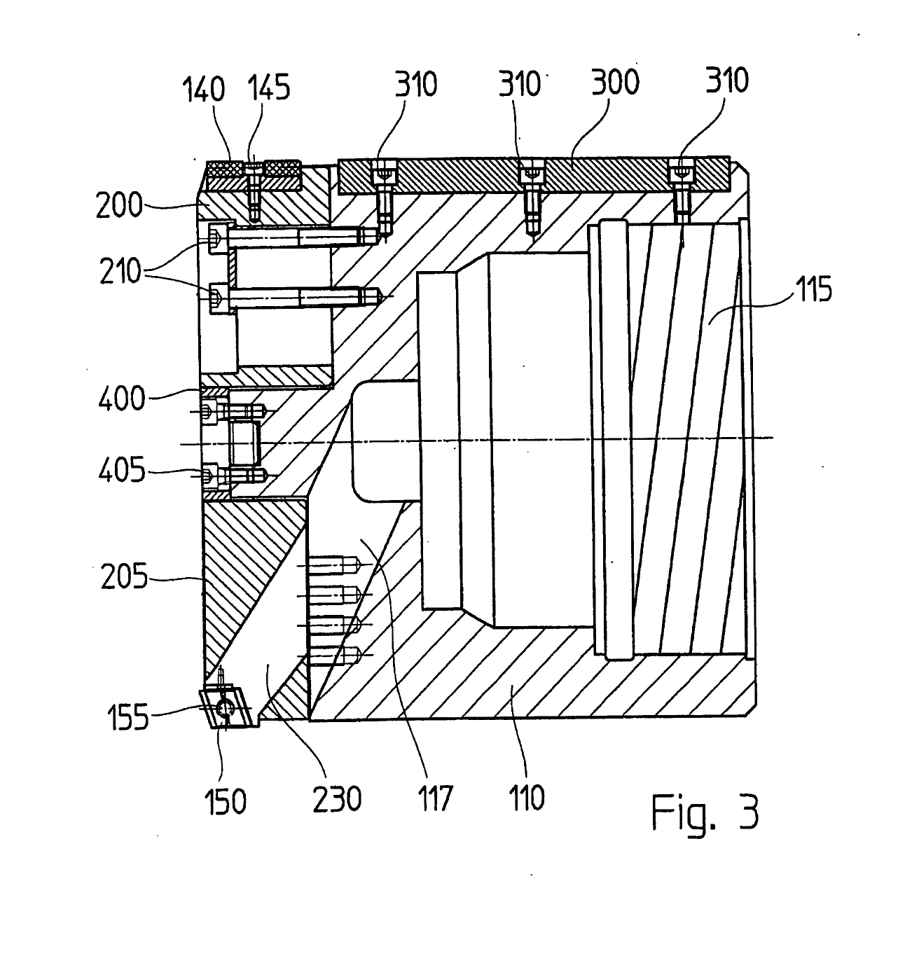

As can be seen especially in FIG. 3, the boring head 100 is provided, on its rear face opposite its front face, with an internal thread 115 by means of which it can be mounted, preferably, on a bore hole tubing.

Both the cutting insert 150 and the guide elements 140 are detachably mounted on their associated cassettes 200 and 205, respectively, for example by means of screws 145, 155.

The cassette 205, which carries the cutting insert 150, comprises a chip removal channel 230 aligned with a chip removal channel 117 provided in the housing 110. This permits the chips produced during the boring process to be removed through the hollow boring head 100.

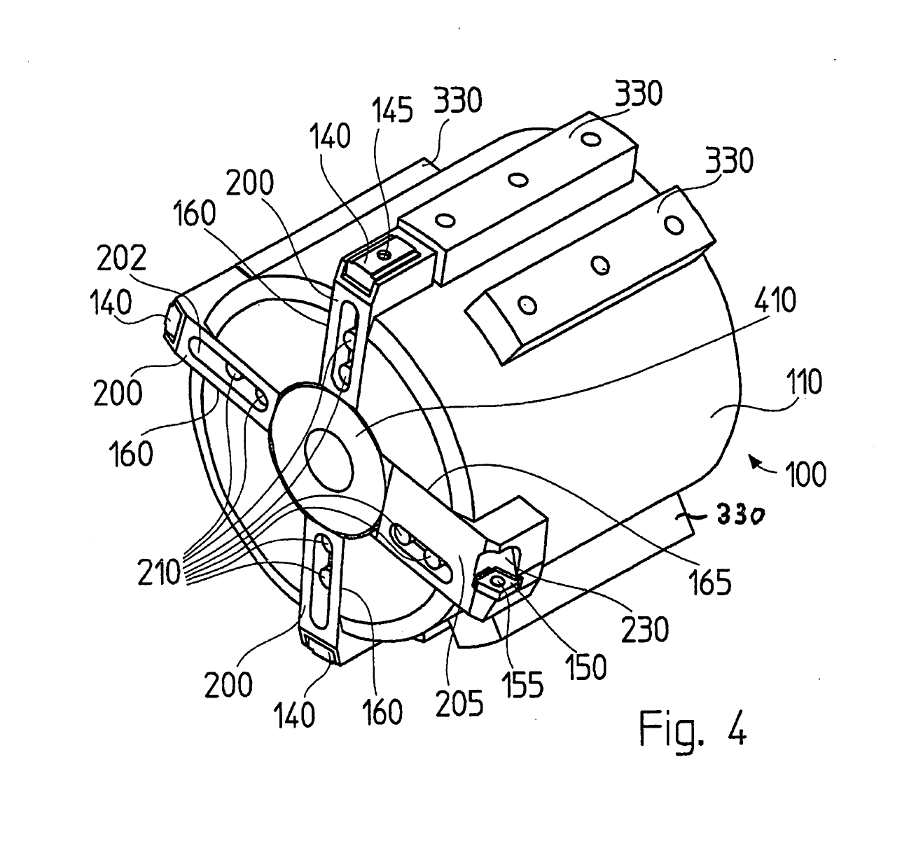

The boring head 100 illustrated in FIGS. 4 to 6 differs from the boring head 100 illustrated in FIGS. 1 to 3 only by an adjustment means 410 of larger diameter, which permits a larger boring diameter to be adjusted. The adjustment means 410 likewise has the shape of a circular disk.

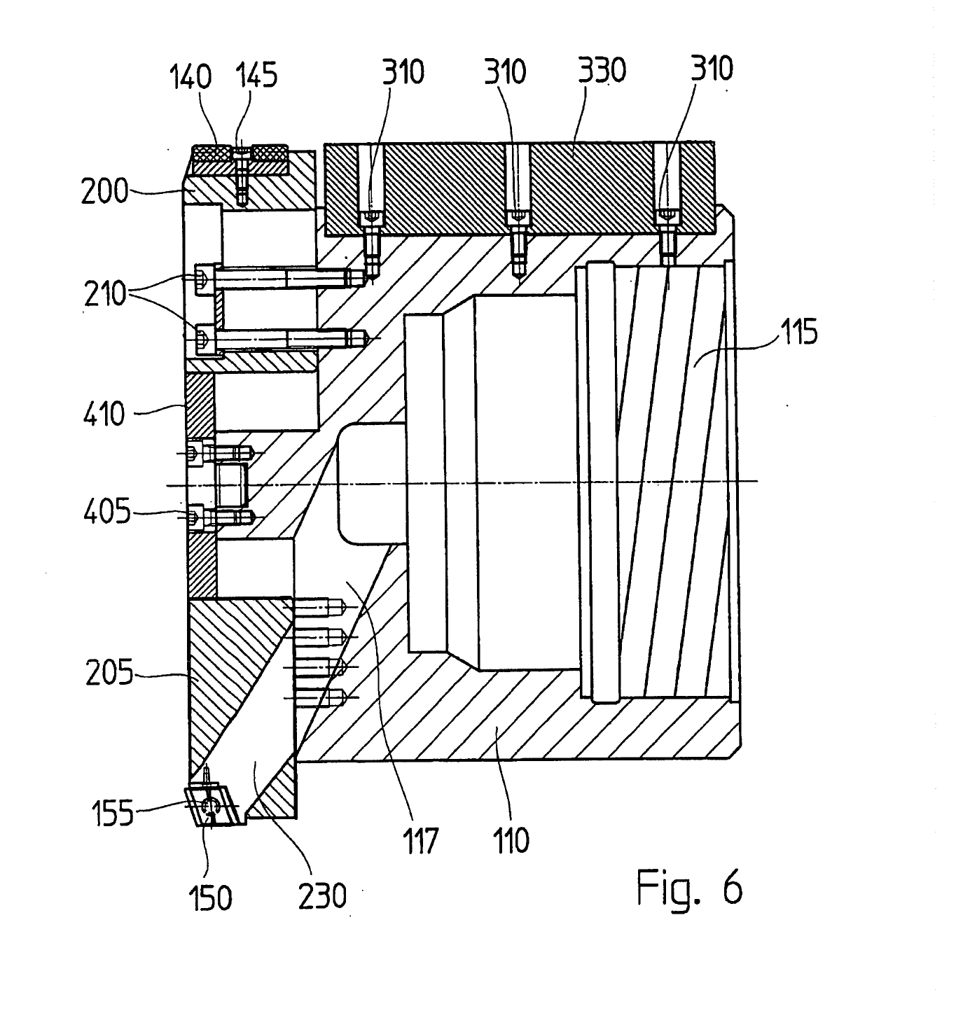

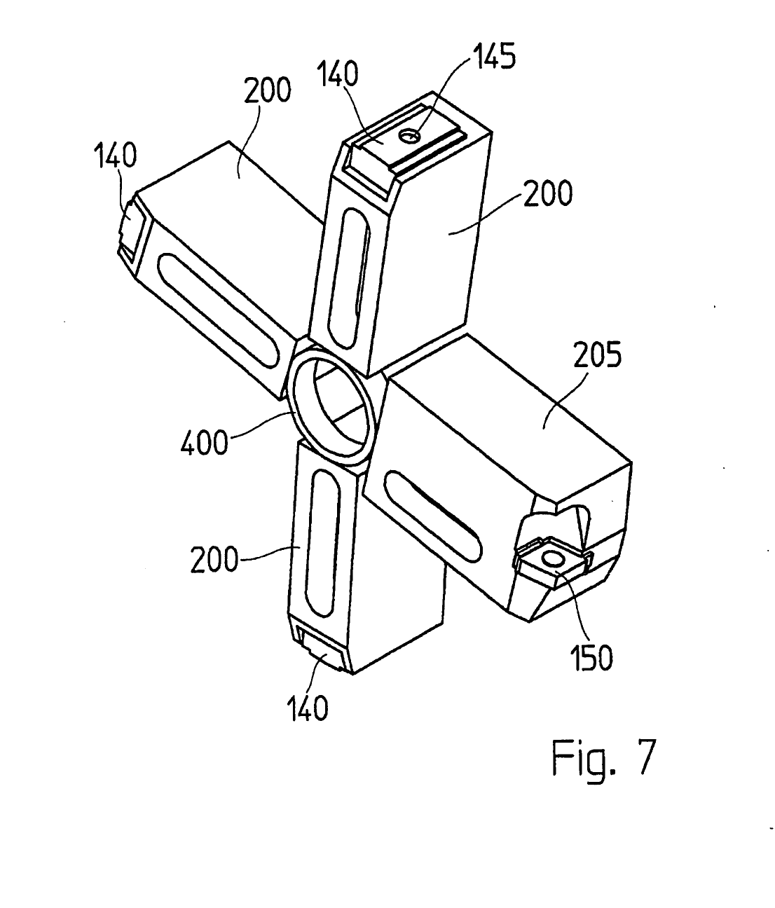

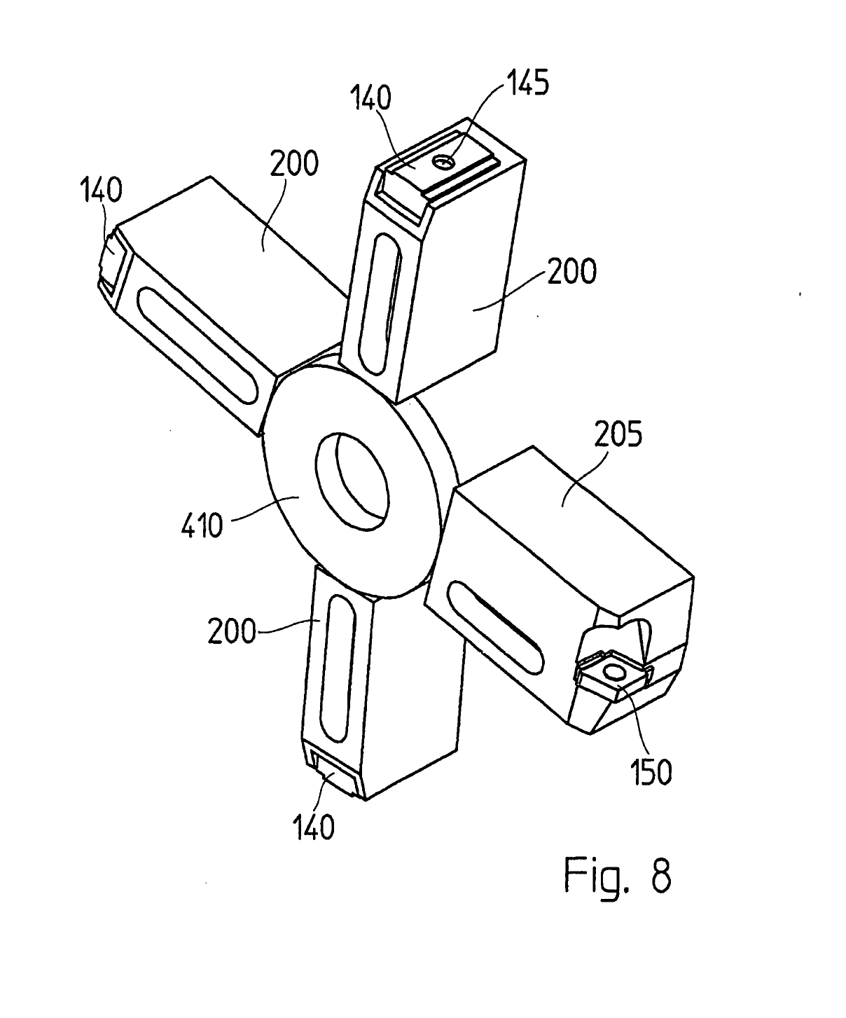

In FIG. 7 and FIG. 8, the two different adjustments are illustrated by way of the different adjustment means 400, 410 and the cassettes 200, 205, which carry the guide elements 140 and the cutting insert 150, while the boring head 100 and its components have been omitted. The configuration of the adjusting elements 400, 410 in the form of a circular disk provides the advantage that a centering bore can be provided in the boring head 100 (not shown). The adjustment means 400, 401 are mounted by means of screws 405, as illustrated in FIGS. 3 and 6.

As can be further seen in FIGS. 4 to 6, when the boring diameter and, thus, the adjustment of the guide elements 140 are changed, different damping strips 330 must be provided which have their radial projection beyond the housing 110 of the boring head adapted to the larger boring diameter.

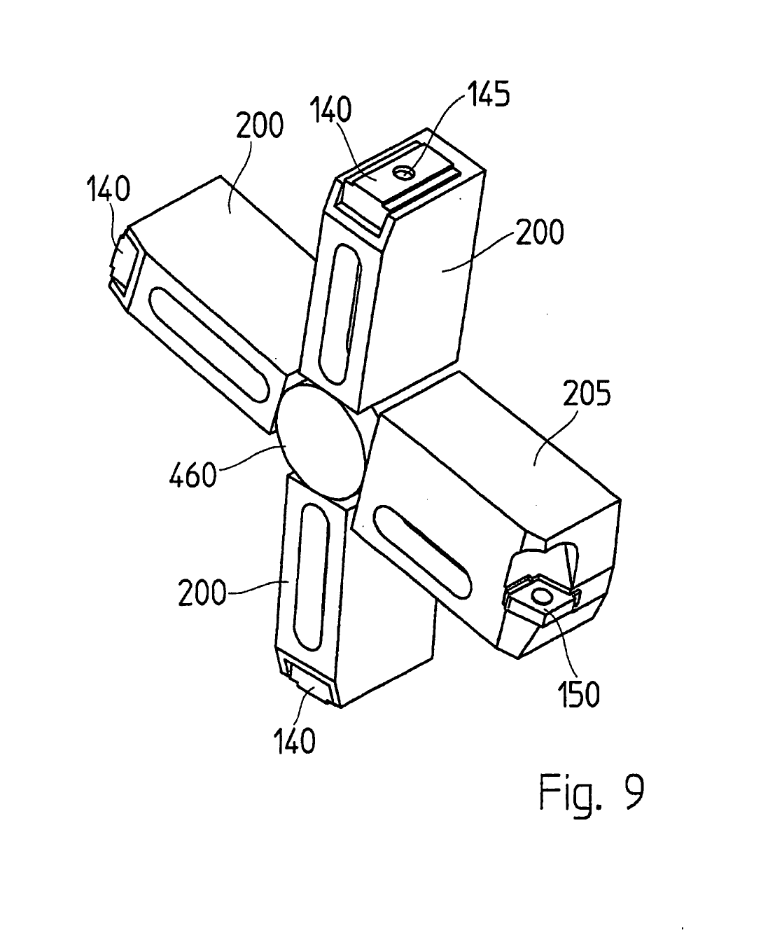

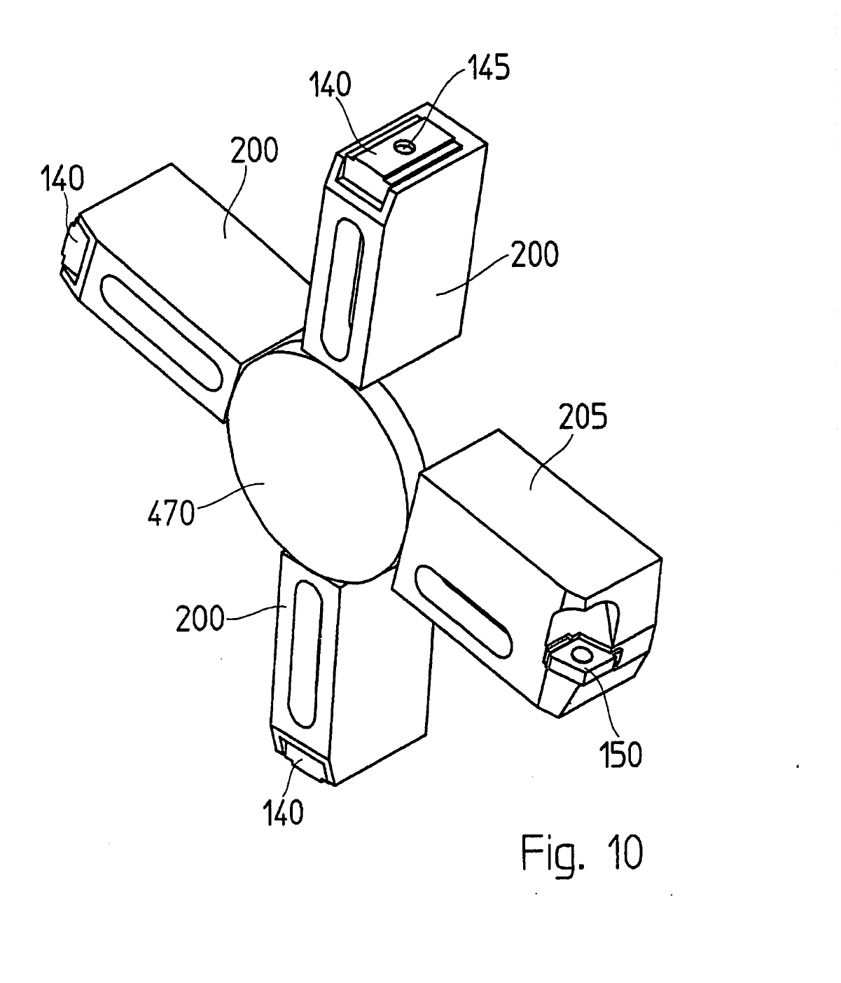

FIGS. 9 and 10 show a diagrammatic representation, in which the boring head 100 and its components have been omitted, of an alternative embodiment of those parts of the boring head 100 which are relevant for adjustment of the boring diameter where adjustment of the cassettes 200, 205 is effected by means of the adjusting elements 460, 470 of different diameters, in the form of circular disks, that can be used as an alternative to the adjusting element 400, 410 in the form of a circular disk illustrated in FIGS. 1 to FIG. 8.

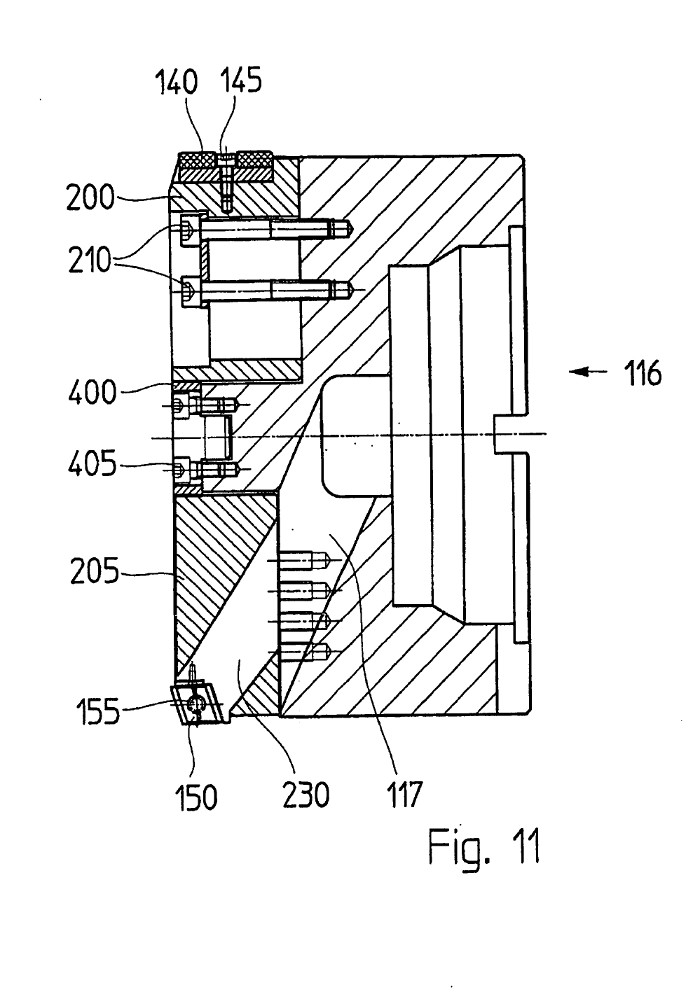

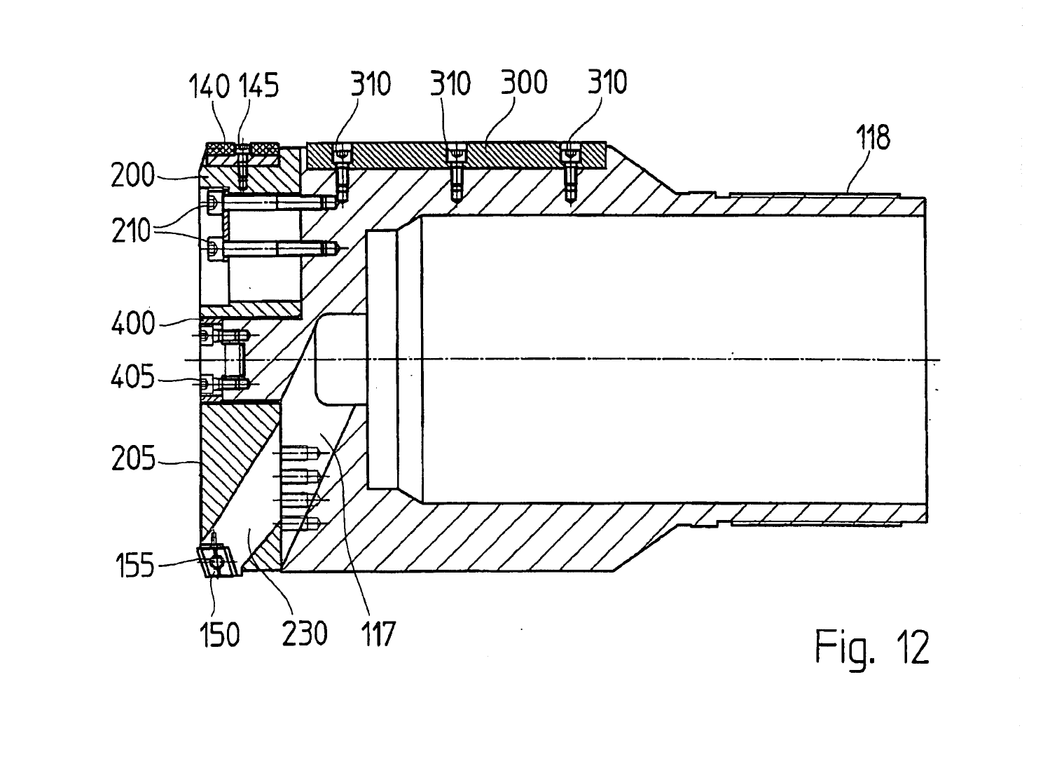

Further, instead of coupling the boring head 100 by means of an internal thread 115 (FIG. 1 to FIG. 6), it is also possible to provide a planar connection 116 or an external thread 118, as illustrated in FIG. 11 and FIG. 12, in which like elements as those used in FIG. 1 to FIG. 10 are indicated by the same reference numerals as in FIG. 1 to FIG. 10.

The big advantage of the boring head 100 described above lies in the fact that the cassettes 200 carrying the guide elements 140 as well as the cassette 205 carrying the cutting insert 150 can be adjusted simultaneously. Further, it is a particular advantage that the adjusting element 400, 410 or 460, 470 can be easily produced in a simple way, for example as a turned part, so that in operation of the boring head 100 it is at any time possible, without great expense, to produce a replacement part, for example if the boring diameter is to be changed or in case of a defect, in which case adjustment will likewise be possible with little input of instrumentation and time.

As a protection for the end face of the boring head 100, a cover disk may be provided which may be detachably mounted on the boring head once the boring diameter has been set and adjusted, and which especially covers the mounting screws 210 of the cassettes, which screws are arranged in longitudinal grooves 202.

1-16. (canceled)

17. A boring head (100), comprising:
a housing (110);
at least one guide element (140) arranged on a periphery of the housing;
at least one cutting insert (150) arranged on the housing;
cassettes (200, 205) radially displaceable in grooves in a face of the boring head, the guide element (140) and the cutting insert (150) being carried by the cassettes;
a single adjustment means (400; 410; 460; 470) for adjusting and aligning a length of projection of both the guide element (140) and the cutting insert (150) beyond the periphery of the housing (110), the adjustment means being adjacent to sides of the cassettes (200, 205) facing away from the guide element (140) and the cutting insert (150), the adjustment means having a peripheral shape adapted to a desired radial distance of the cassettes (200, 205) from an axis of symmetry of the boring head (100) so that the projection lengths of the guide element (140) and the cutting insert (150) are simultaneously adjusted and aligned as the adjustment means (400; 410; 460; 470) is mounted on the boring head (100).

18. The boring head is defined in claim 17 wherein the adjustment means (400; 410; 460; 470) is mountable on the face of the boring head (100).

19. The boring head as defined in claim 17 wherein the adjustment means is arranged centrally to the axis of the boring head.

20. The boring head as defined in claim 19, wherein the adjustment means is arranged substantially concentrically to the axis of the boring head.

21. The boring head as defined in claim 17, wherein the adjustment means is arranged eccentrically to the axis of the boring head.

22. The boring head as defined in claim 17, wherein the surface defining the outer periphery of the adjustment means has a desired, including a non-symmetrical, shape.

23. The boring head as defined in claim 17, wherein the adjustment means is cylindrical in the axial direction.

24. The boring head as defined in claim 17, wherein the adjustment means is disk-shaped.

25. The boring head as defined in claim 24, wherein the adjustment means has the shape of a circular disk (460, 470).

26. The boring head as defined in claim 17, wherein the adjustment means has an annular shape.

27. The boring head as defined in claim 26, wherein the adjustment means is shaped as a circular ring (400, 410).

28. The boring head as defined in claim 17, wherein the adjustment means has a conical shape in the axial direction.

29. The boring head as defined in claim 28, wherein the adjustment means can be displaced in the axial direction.

30. The boring head as defined in claim 17, and further comprising detachable mounting elements for fixing the cassettes (200, 205) after adjustment and alignment.

31. The boring head as defined in claim 30, wherein the mounting elements are screws.

32. The boring head as defined in claim 17, wherein the cassette (205) carrying at least one cutting insert (150) comprises a chip removal channel (230) which is connected with a further chip removal channel (117) provided in an interior of the boring head (100) in both a non-displaced and a displaced condition of the cassette (205).

33. The boring head as defined in claim 17, wherein damping strips (300, 330) are arranged on the periphery of the boring head (100) and have a radial extension beyond the periphery of the boring head housing (110) that is adapted to the projection length of the guide element and the projection length of the cutting insert (150) beyond the periphery of the boring head housing (110).

34. The boring head as defined in claim 17, wherein the boring head (100) is provided on its end face with a cover arranged to at least partially cover the adjustment means (400; 410; 460; 470) and the cassettes (200, 205).
